(19) United States
(12) Patent Application Publication
(10) Pub. No.: US 2007/0207398 A1
(43) Pub. Date: Sep. 6, 2007

(54) ELECTROSTATIC IMAGE DEVELOPING TONER

(75) Inventors: Kaori ONO, Tokyo (JP); Hiroshi YAMAZAKI, Tokyo (JP); Takato CHIBA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 11/615,117

(22) Filed: Dec. 22, 2006

(30) Foreign Application Priority Data
Mar. 3, 2006 (JP) 2006-057382

(51) Int. Cl. G03G 9/09

(52) U.S. Cl. 430/107.1; 430/111.4; 430/110.4; 430/108.3; 430/109.3

(57) ABSTRACT

An electrophotographic toner is disclosed. The toner is composed of toner particles comprising colored particles containing a dye which is dispersed in a binder resin, wherein the toner particles satisfies formula of 3≧D2/D1>1, D1 being a volume average particle diameter of the colored particles, and D2 being an average diameter of dye cloud formed by the colored particles in the toner particle.

This application claims priority from Japanese Patent Application No. JP2006-057382, filed on Mar. 3, 2006, which is incorporated hereinto by reference.

### FIELD OF THE INVENTION

The present invention relates to an electrostatic image developing toner employed for electrophotographic methods, and an image forming method.

### BACKGROUND OF THE INVENTION

In image formation employing electrophotographic methods, generally, by exposing light information in response to image information onto a photoreceptor incorporating photoconductive materials, an electrostatic image is formed on the above photoreceptor, and the above electrostatic image is developed employing a charged toner to result in a toner image. The resulting toner image is transferred onto an image recording medium such as paper, followed by fixing the image by application of heat, pressure, or solvent vapor, whereby a visible image is produced.

In formation of such as full-color images employing the above electrophotographic method, an electrostatic image based on image information related to each color, which is formed on a plurality of photoreceptors, is developed employing each of yellow, magenta, cyan, and black toners to form a toner image of each color, and these toner images are superimposed and transferred, followed by a fixing process, whereby a full-color image is produced.

Such color toner is composed of colorants of each color dispersed into binder resins. Employed as colorants used in these color toners are organic pigments or dyes known in the art, each of which exhibits various drawbacks.

For example, organic pigments are commonly superior to dyes in terms of heat resistance and lightfastness. However, organic pigments are present in such a state that they are dispersed into binder resins in the form of aggregated particles and exhibit low dispersibility, whereby the resulting toner exhibits high covering power resulting in low transparency. Consequently, of the color toners of each color which are superimposed to form images, the toner in the lowermost layer is hidden by the layers above it, whereby problems occur in which colorfulness is lowered due to difficulty of viewing the color of the toner in the lowermost layer, resulting in degradation of the color reproduction of images.

In order that of the color toners of each color which are superimposed to form images, so that the toner of the lowermost layer is not hidden by layers above it, specifically so that the color of the above lowermost layer can be viewed, it is necessary that fixed toners exhibit high transparency. Further, in order to realize excellent color reproduction, high dispersibility and tinting strength of colorants are required.

Further, in principle, it is possible to reproduce all colors, based on the subtractive mixture of the three primary colors consisting of yellow, magenta, and cyan. When color images are formed employing color toners incorporating pigments, in practice, the range and chroma of reproducible color are occasionally limited due to spectral characteristics of the pigments dispersed into binder resins and color mixing properties during superimposition of toners of different colors, whereby it is a concern that the colors of documents may not be faithfully reproduced.

In order to overcome the above drawbacks of pigments, a method is proposed in which by employing a flushing method as a pigment dispersion method, pigments are dispersed into dispersed particles at a sub-micron order of the primary particles without formation of secondary aggregated particles, whereby transparency is enhanced (refer, for example, to Patent Document 1), while another method is proposed which improves electrification properties, fixability, and image uniformity by covering pigments in the form of minute particles with binder resins and outer shell resins (refer, for example, to Patent Document 2).

However, even by employing these methods, it has been difficult to improve toners incorporating pigments as a colorant to exhibit the targeted transparency and chroma.

On the other hand, dyes are present in such a state that they are dissolved in toner particle-forming binder resins to exhibit the targeted transparency and chroma. However, due to these characteristics, they exhibit drawbacks in which their light fastness and heat resistance are significantly inferior to pigments. When dyes are insufficient in heat resistance, they are decomposed due to heat to result in a decrease in image density. Further, when toner images are fixed based on a contact heating system, dyes may be sublimed to stain the interior of production devices. Still further, problems occur in which dyes are dissolved in silicone oil employed during fixing and are finally transferred to and fused onto the heating roller to result in offset phenomena.

Proposed as a method to overcome such drawbacks of dyes is one in which by employing certain specified anthraquinone based dyes, lightfastness and color reproduction become compatible (refer to, for example, Patent Document 3).

However, in order to prepare images realizing the targeted color reproduction, it is ideal to employ colorants composed of dyes of all colors of color toners of the three primary colors (cyan, magenta, and yellow) to be superimposed. When the above specified anthraquinone based dyes are employed, only a magenta toner is composed of the specified dyes. Subsequently, for example, upon considering the color reproduction in the blue region, pigments should be use the cyan and yellow colorants, whereby it is not possible to obtain sufficient overall transparency.

(Patent Document 1) Japanese Patent Publication Open to Public Inspection (hereinafter referred to as JP-A) No. 9-26673

(Patent Document 2) JP-A No. 11-160914

(Patent Document 2) JP-A No. 8-69128

### SUMMARY OF THE INVENTION

In view of the foregoing, the present invention was achieved. An object of the present invention is to provide an electrostatic image developing toner which exhibits sufficient transparency and chroma, excellent color reproduction as well as excellent electrification characteristics, and forms an image exhibiting excellent heat resistance and sufficient retention qualities, and consequently is capable of maintaining image characteristics for an extended period of time, and an image forming method using the same.

In the electrostatic image developing toner of the present invention, which is composed of toner particles which are prepared by dispersing minute colored particles containing a dye at volume average particle diameter D1 into a toner particle forming binder resin, it is characterized in that Relational Formula (1) 3≧D2/D1>1 is held, wherein D2 represents the average diameter of the dye cloud formed by the above minute colored particles in a toner particle.

In the electrostatic image developing toner of the present invention, difference between the SP value of the above toner particle forming binder resin and the SP value of WhH DERvH PinuWH FRORrHd SDrWiFOHs is SrHIHrDEOy RI 0-4 (cal/cm³)^{1/2}.

In the electrostatic image developing toner of the present invention, dyes constituting minute colored particles are preferably oil-soluble dyes or metal chelate dyes.

Further, in the electrostatic image developing toner of the present invention, minute colored particles may be composed of a dye, a dye medium resin differing from the toner particle forming resins and/or a surfactant.

The image forming method is one which includes at least a development process which develops an electrostatic image formed on an electrostatic image carrying body, employing an electrostatic image developing toner and a transfer process which transfers the toner image formed during the aforesaid development process onto an image recording medium and the aforesaid electrostatic image developing toner is employed.

By employing the electrostatic image developing toner of the present invention, dyes as a colorant are dispersed into toner particles in the form of minute colored particles, and further, volume average particle diameter D1 and an average diameter D2 of the dye cloud formed via the above dyes are regulated to satisfy the specified relational formula, whereby sufficient heat resistance and high offset resistance are realized, and further, excellent color reproduction based on sufficient transparency and chroma and desired electrification characteristics are also realized. As a result, the quality of images formed employing the above electrostatic image developing toner can be maintained for a relatively long time.

### BRIEF DESCRIPTION OF THE DRAWING

FIG. 1: A schematic view of section of a toner particle of the electrostatic image developing toner according to the present invention for explanation.

FIG. 2: A schematic view of section of a toner particle of the electrostatic image developing toner according to the present invention in which the colored particle composing the toner particle has a core/shell structure for explanation.

### EMBODIMENTS OF THE INVENTION

The present invention will now be specifically described.

The electrostatic image developing toner (hereinafter DOsR siPSOy rHIHrrHd WR Ds WhH “WRnHr”) RI WhH SrHsHnW invention is composed of toner particles which are prepared by dispersing minute colored particles of a volume average particle diameter of D1, incorporating dyes into toner particle forming binder resins (hereinafter also referred to Ds WhH “WRnHr EindHr rhsins”, Dnd rHODWiRn 3≧D2/D1>1 is satisfied, wherein D2 represents an average diameter of a dye cloud formed by the aforesaid minute colored particles.

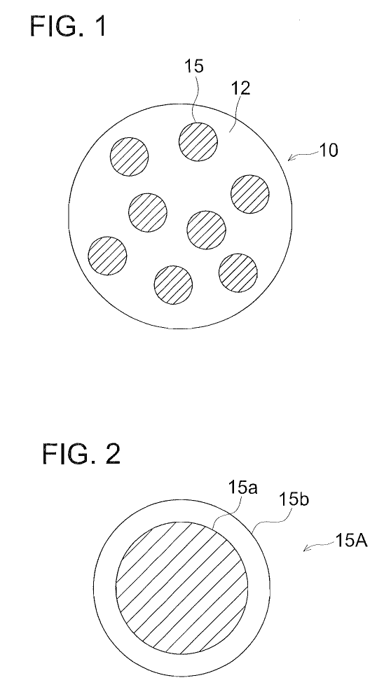

Further, FIG. 1 is a schematic sectional view depicting toner particle 10 of the present invention, and numeral 12 represents a toner binder resin while 15 represents a minute colored particle.

The dye cloud formed of minute colored particles in the toner binder resins, as described herein, is produced as follows. When dye is dispersed into toner binder resins to form minute colored particles, in cases in which the dye exhibits sufficiently compatibility (being solubility) in the above toner binder resins, the dye is diffused into the toner binder resins to form colored portions, each of which is larger than genuine volume average diameter D1 of the minute FRORrHd SDrWiFOIH. “DyH FORud” rHIHrs WR WhH DERvH FRORrHd portion.

Average diameter D2 of the above dye cloud is SrHIHrDEOy 10-500 nP, EuW is PRrH SrHIHrDEOy 20-200 nP.

When D2/D1 in above Relational Formula (1) is equal to 3 or more, dyes bleed to the surface of toner particles to result in degradation of electrification properties of the toner, whereby it is a concerned that bleeding occurs in formed images, and during heat fixing, dye sublimation and oil staining occur. On the other hand, when in above Relational Formula (1), D2/D1 is equal to 1 or less, the above dyes are present in toner binder resins in the state of a near solid due to insufficient solubility in the toner binder resins, whereby it is a concern that the resulting color reproduction and transparency will degrade due to the presence of a toner in which minute colored particles are aggregated.

Values D2/D1 of an average diameter D2 of the dye cloud to volume average particle diameter D1 is most preferably of 2.95≧D2/D1>1.05. When value D2/D1 is in the above range, dyes exhibit sufficient compatibility with toner binder resins, even though dye bleeding is retarded. As a result, the resulting toner exhibits excellent targeted effects.

It is possible to determine diameter of the dye cloud formed by a minute colored particle in the toner binder resins by observing the cross-section of the toner, via a transmission electron microscope (TEM). Such microscope makes it possible to observe the internal structure of substances via an electron diffraction pattern or a transmission electron microscopic image which is obtained in such a manner that electron beams are allowed to transmit a sample to result in scattering and diffraction due to the atoms in the sample. In the present invention, a sample was prepared in such a manner that a toner particle was cut to a thickness of 0.2 μm, employing a microtome. The resulting sample was employed to form a transmission electron microscopic image (being a TEM image) at a magnification factor of 100,000. The arithmetical average value in the Fere direction of, for example, 100 dye clouds was designated as an average diameter D2 of the dye cloud.

In the toner of the present invention, volume average particle diameter D1 of the minute colored particles to be dispersed into the toner binder resins, which constitute the WRnHr, is SrHIHrDEOy RI 10-500 nP in viHw RI WRnHr production and color reproduction in the resulting images, EuW is PRrH SrHIHrDEOy RI 20-400 nP. By WDNinJ suiWDEOH average volume particle diameter D1, good stability of minute colored particles in the resulting toner is obtained due to the adequate surface area per unit volume, whereby good light fastness is obtained. And further, precipitation during formation of minute colored particles is retarded to result in high standing stability and further, the resulting toner exhibits sufficient transparency, and it is possible to achieve sufficient glossiness of the formed images.

It is possible to determine volume average particle diameter D1, employing for example, a dynamic light scattering method, a laser diffraction method, a centrifugal method, a Field Flow Fractionation (FFF) method, and an electrical detection method. In the present invention, it is preferable to determine it employing the dynamic light scattering method, while using MASTER SIwER (produced by Malvern Co.).

In the toner of the present invention, the difference between the SP value of the toner binder resin constituting a toner and the SP value of the dye constituting minute colored SDrWiFOHs is SrHIHrDEOy RI 0-4 (FDO/FP³)^{1/2}, but is more SrHIHrDEOy RI 0-3 (FDO/FP³)^{1/2}, and particularly preferably 0.1-2.0 (cal/cm³)^{1/2}.

When the difference between the SP value of the toner binder resin constituting a toner and the SP value of the dye FRnsWiWuWinJ PinuWH FRORrHd SDrWiFOHs is in WhH rDnJH RI 0-4 (cal/cm³)^{1/2}, the toner binder resin and the dye in the minute colored particles result in targeted compatibility, whereby it is possible to obtain a dye cloud of a preferred state (diameter) in the toner binder resins by dispersing the minute colored particles into the toner binder resins to result in inclusion.

SP value (solubility parameter), as described herein, refers to solubility parameter δ, which is the intrinsic value of a compound, being calculated based on formula δ=(ΔE/s), wherein ΔE represents the molecular aggregation energy density while s represents molar volume and is a useful scale to predict the solubility of a compound. A high SP value results in high polarity, while a low SP value results in low polarity. In the case of blending two types of such compounds, as the difference between the two SP values decreases, solubility increases.

SP values may be determined employing various methods such as a viscosity method, a degree of swelling method, a gas chromatographic method, or a turbidity method, which result in nearly similar values. Further, SP values of organic solvents and resins are listed on page 337 in Is of “32/Y0(5 HA1DB22.” (-. BrDndruS, HW DO., A :iOHy-, nWHrsFiHnFH 3uEOiFDWiRn), Rn SDJHs 78-RI .RzR 6hinRdD, “YRHNi WR YRNDidR (6ROuWiRns Dnd 6ROuEiOiWy)” (ODruzHn CR., /Wd., published in 1991), as well as other pertinent references.

In the present invention, a method is preferred which calculates SP values (cal/cm³)^{1/2} based on A. h. dhost et al., J. Comput. Chem. 9:80 (1988), employing PROJECT iEADER in PROHFuOH FDOFuODWiRn SDFNDJH “CACHH” (SrRduFHd Ey)uMiWsu itd.).

In the toner of the present invention, the content ratio of minute colored particles in toner particles is, for HxDPSOH, SrHIHrDEOy 1-30% Ey wHiJhW, EuW is PRrH SrHIHrDEOy 1-20% Ey wHiJhW.

In the toner of the present invention, minute colored particles dispersed in toner binder resins may contain, in addition to a dye, dye media resin which is of a different type from the toner binder resin and/or a surfactant, and may further contain other additives such as an antioxidant or a rs absorber.

It is possible to prepare minute colored particles exhibiting various abilities when dye media resins and surfactants other than the dyes in minute colored particles are contained.

Further, by incorporating dye medium resins in minute colored particles, dispersion stability of the minute colored particles is enhanced, and it is possible to consistently control the resulting particle diameter.

Resins which are of a different type from the toner binder resins, as described herein, refer to resins which exhibit low compatibility with the above toner binder resins. For example, resins, which exhibit high compatibility with toner binder resins, may exhibit no compatibility during the production process of the toner, due to an excessively high glass transition point of either or both resins, and such resins are also included in the toner of the present invention.

When minute colored particles, which constitute the toner of the present invention, contain a dye medium resin, the content ratio of dye in the minute colored particles is SrHIHrDEOy 5-90% Ey wHiJhW, EuW is PRrH SrHIHrDEOy 10-80% by weight. In order to realize the above content ratio, it is preferable that the compatibility with used dyes is exceedingly high. Depending on combinations of employed dyes and dye media resins, it is possible to realize desired compatibility, utilizing various types of intermolecular forces such as an ionic bond, a coordination bond, a hydrogen bond, or π-π interaction.

Further, when minute colored particles, which constitute the toner of the present invention, contain surfactants, the content ratio of the surfactants in the PinuWH FRORrHd SDrWiFOHs is SrHIHrDEOy 5-70% Ey wHiJhW, EuW is PRrH SrHIHrDEOy 10-50% Ey wHiJhW.

Further, minute colored particles, which constitute the toner of the present invention, contain both dye media resins and surfactants, the content ratio of dyes in the minute FRORrHd SDrWiFOHs is WR EH SrHIHrDEOy 10-80% Ey wHiJhW, EuW is WR EH PRrH SrHIHrDEOy 20-70% Ey wHiJhW, whiOH WhH content ratio of the dye medium resins is to be preferably 10-80% Ey wHiJhW, EuW is WR EH PRrH SrHIHrDEOy 20-70% Ey weight.

Further, as shown in FIG. 2, in the toner of the present invention, the minute colored particle dispersed in toner binder resins may be structured as minute colored particle 15A, exhibiting a core-shell structure, which is composed of core particle 15a containing dyes and shell layer 15b which is composed of shell layer forming resins (hHrHinDIWHr DOsR rHIHrrHd WR Ds “shHOO rHsins”) FRnWDininJ substantially no dyes, which cover the exterior surface of core particle 15a. In this case, the difference in SP value between the shell resins and the dyes, constituting minute FRORrHd SDrWiFOHs, is SrHIHrDEOy 0-4(FDO/FP³)^{1/2}, and is PRrH SrHIHrDEOy 0-3 (FDO/FP³)^{1/2}, and the shell resins are those which are different from the toner binder resins in terms of type. Specific examples of combinations of shell resins and toner binder resins include a combination of high polarity and low polarity resins and of resins exhibiting different SP values.

The thickness of above shell layer 15b is preferably 1-50 nP.

The relation of the toner particle satisfies formula of 1.2≧D2/D1>1.05 in case that the minute colored particles are core-shell particles.

In a toner incorporating such core-shell structure minute colored particles, it is possible to retard, to some extent, diffusion of dyes from the minute colored particles, due to the presence of the shell layer, whereby even though toner binder resins which exhibit high dye solubility are employed, it is possible to satisfy above Relational Formula (1) between volume average diameter D1 and dye cloud diameter D2.

By constituting minute colored particles to result in a core-shell structure, it is possible to employ the same shell resins which constitute minute colored particles of the toner particles of each color, whereby it is possible to employ the same conditions for the following production of toner particles, enabling lower production cost.

In minute core-shell structure colored particle 15A, shell layer 15b may completely or only partially cover core particle 15a. Further, some of shell resins constituting shell layer 15b may form domains in core shell 15a. Further, shell layer 15b may be of a multilayered structure of at least two layers, each of which is composed of different resins. In such a case, it is acceptable that resins constituting the uppermost layer are different from toner binder resins.

### YToner Production Method>

listed as methods to produce the toner of the present invention may be a kneading-pulverization method, a suspension polymerization method, an emulsion polymerization method, an emulsion polymerization aggregation method, an encapsulation method, and other prior art methods. Upon considering necessity of preparing a particle size reduced toner to produce higher quality images, as a toner production method, it is preferable to employ the emulsion polymerization aggregation method in view of production cost and storage stability.

In the emulsion polymerization aggregation method, toner particles are produced as follows. A dispersion incorporating minute particles (hereinafter referred to as “PinuWH WRnHr EindHr rHsin SDrWiFOHs”) FRPSRsHd RI WRnHr binder resins prepared via an emulsion polymerization method is blended with a dispersion incorporating toner particle constituting components such as other minute colored particles, and the resulting mixture is gradually aggregated while balancing repulsion force of the surface of minute particles via pH adjustment and aggregation force via the addition of aggregating agents composed of electrolytes. Further, association is carried out while controlling the average particle diameter and the particle size distribution and at the same time, fusion among minute particles is carried out while controlling the shape, whereby toner particles are produced.

When the emulsion polymerization aggregation method is employed as a method to produce the toner of the present invention, it is possible to structure the resulting minute toner binder resin particles composed of at least two layers composed of toner binder resins which differ in composition. In such a case, it is possible to utilize a method in which polymerization initiators and polymerizable monomers are added to the first resin particle dispersion prepared via a common emulsion polymerization process (being a first polymerization stage) and the resulting system undergoes a polymerization process (a second polymerization stage).

A specific example, in which the emulsion polymerization aggregation method is employed as a method to produce the toner of the present invention, will be described. The above method includes: (1) a minute colored particle preparing process which produces minute colored particles, incorporating dyes, and if desired, dye media resins and/or surfactants, (2) a minute toner binder resin particle polymerization process to prepare minute toner binder resin particles incorporating, if desired, non-offsetting agents and charge controlling agents, (3) a salting-out, aggregation, and fusion process which forms toner particles by salting-out, aggregating and fusing minute toner binder resin particles with minute colored particles in an aqueous medium, (4) a filtration-washing process which collects toner particles from the toner particle dispersion system (being the aqueous medium) via filtration and removes surfactants and the like from the above toner particles, (5) a drying process which dries washed toner particles, and (6) a process in which external additives are added to the dried toner particles.

“ATuHRus PHdiuP”, Ds dHsFriEHd hHrHin, rHTHrs WR D PHdiuP FRPSRsHd RI 50-100% Ey wHiJhW RI wDWHr Dnd 0-50% by weight of water-soluble organic solvents. Exemplified as water-soluble organic solvents are methanol, ethanol, isopropanol, butanol, acetone, methyl ethyl ketone, and tetrahydrofuran, and of these, preferred are alcohol based organic solvents which do not dissolve the resulting resins.

### YMethod for Forming Minute Colored Particles>

It is possible to prepare the minute colored particles, constituting the toner of the present invention, in such a manner that a dye incorporating liquid composition, which is prepared by dissolving dyes in or dispersing the same into water-immiscible organic solvents such as ethyl acetate or toluene, is emulsify-dispersed employing a homogenizer, and thereafter, an in-liquid drying method is employed which allows minute colored particles to be deposited upon removing water-immiscible organic solvents.

Further, when minute colored particles contain dye media resins, it is possible to prepare minute colored particles in such a manner that a dispersion, which is prepared in advance by dispersing minute resin particles composed of dye medium resins into an aqueous medium employing an emulsion polymerization method, and the resulting dispersion composed of minute resinous particles is blended with an organic solvent solution in which dyes are dissolved, followed by impregnation of dyes into the minute resinous particles.

Further, when minute colored particles contain dye media resins and/or surfactants, a dye incorporating solution is prepared in such a manner that dye media resins and/or surfactants are further dissolved, whereby it is possible to prepare the minute colored particles employing the resulting dye incorporating solution while employing the above in-liquid drying method.

Still further, when minute colored particles are those of a core-shell structure, dye incorporating core particles prepared via the above method and polymerizable monomers having a polymerizable unsaturated double bond are added to an aqueous medium incorporating surfactants to undergo emulsion polymerization, so that the above polymerizable monomers undergo polymerization, followed by deposition onto the surface of the core particles to form a shell layer, whereby it is possible to prepare minute colored particles of a core-shell structure.

Homogenizers employed in the in-liquid drying method are not particularly limited, and it is possible to employ, for example, an ultrasonic homogenizer or a high speed stirring type homogenizer.

Common dyes are usable in this invention, and oil-soluble dyes are preferred and chelate dyes are more preferred.

Usually, oil-soluble dyes which do not contain any water-solubilizing group such as a carboxylic acid or sulfonic acid group, are soluble in organic solvents and not soluble in water, but a dye obtained by salt-formation of a water-soluble dye with a long chain base and thereby being soluble in oil, is also included. There are known, for example, an acid dye, a direct dye and a salt formation dye of a reactive dye with a long chain amine.

Examples of the oil soluble dyes are listed.

Yellow Dye: C.I. Solvent Yellow 2, 3, 5, 7, 8, 17, 24, 30, 31, 35, 44, 88, 89, 98, 102, 103, 104, 105, 111, 114, and 162, and C.I. Disperse Yellow 160;

Magenta Dye: C.I. Solvent Red 3, 14, 17, 18, 22, 23, 51, 53, 87, 127, 128, 131, 145, 146, 149, 150, 151, 152, 153, 154, 155, 156, 157, 158, 176, 179 C.I. Solvent Orange 63, 68, 71, 72 and 78; and

Cyan Dye: C.I. Solvent Blue 4, 8, 19, 21, 22, 50, 55, 63, 78, 82, 83, 84, 85, 86, 90, 91, 92, 93, 94, 95, 97 and 104.

Mixture of these may be employed.

In addition, phenol, naphthols; cyclic methylene as pyrazolone and pyrazolotriazole, couplers such as ring-opening methylene compounds, p-diaminopyridines, azomethine dyes and indoaniline dyes are also usable as an oil-soluble dye.

A metal chelate dye usable in this invention refers to a compound in which a dye coordinates with a metal ion through at least two-dentate coordination and which may contain a ligand other than the dye. The ligand refers to an atomic group capable of coordinating with a metal ion, which may contain a charge or not.

Metal chelate dyes usable in this invention are, for example, compounds represented by the following formula (D):

M(Dye)ᵢ(A)ₘ formula (D)

whHrHin 0 is D PHWDO iRn, “DyH” is D dyH FDSDEOH RI coordinating with a metal ion, A is a ligand except for that the Dye, i is 1, 2 or 3, and m is 0, 1, 2 or 3, provided that whHn P is 0, / is 2 Rr 3, in whiFh SOurDO “DyH”s PDy EH WhH same or different.

The metal ion represented by M is a metal ion chosen from groups 1 to 9 inclusive of the periodical table of elements, for example, Al, Co, Co, Cr, Cu, Fe, Mn, Me, Ni, Sn, Ti, Pt, Pd, wr, and wn. Ni, Cu, Cr, Co, wn, and Fe ions are specifically preferred in view of color hue and various stabilities. And further Cu and Ni are more preferable in view of hue and clarity, further Cu is most preferable in view of safety.

Preferable dyes are those composed of metal ion represented by M and a dye having aromatic hydrocarbon ring or heterocyclic ring which is a metal chelate dye formed by allowing at least one dye to be bonded to a metal ion through coordination of the coordination number (or dentate number) of 2 or more, and a dye represented by a chelating agent. Chelate dyes described in JP-A Nos. 9-277693, 10-20559 and 10-30061 are specifically preferred, which is a metal chelate dye formed by allowing at least one dye to be bonded to a metal ion through coordination of the coordination number (or dentate number) of 2 or more.

The above mentioned dye may be employed singly or in plurality in combination as necessity.

As for a black colorant composing a black toner, carbon black, magnetic material, dye, pigment etc. may be used optionally, and concretely examples include channel black, farness black, acetylene black, thermal black and ramp black for the carbon black; ferromagnetic metal and alloy composed of the metal such as iron, nickel and cobalt for the magnetic material, a ferromagnetic compound such as ferrite and magnetite, alloy containing no ferromagnetic metal but displaying ferromagnetic characteristics by heat treatment, for example, so called Heustler alloy such as Mn—Cu—Al and Mn—Cu—Ti, chrome dioxide and so on.

### Dye Medium Resin

A resin may be employed as the dye medium resin so long as it differs in composition from the toner biding resin described above, in case that the colored particle contains a dye medium resin. Examples thereof include a dye medium resin obtained by polymerizing polymerizable ethylenically unsaturated double bond such as (meth)acrylate resin, polyester resin, polyamide resin, polyimide resin, polystyrene resin, polyepoxy resin, amino type resin, fluorinated resin, phenol resin, polyurethane resin, polyethylene resin, polyvinyl chloride resin, polyvinyl alcohol resin, polyether resin, polyether ketone resin, polyphenylene sulfide resin, polycarbonate resin, and aramid resin. Of these resins, resins obtained by polymerization of ethylenically unsaturated monomers are preferred, such as (meth)acrylate resin, polystyrene resin, polyethylene resin, polyvinyl chloride resin and polyvinyl alcohol resin. (Meth)acrylate resin and polystyrene resin are specifically preferred. The above mentioned dye medium resin is employed singly or in plurality in combination.

(Meth)acrylate resin can be synthesized by homopolymerization or copolymerization of various methacrylate monomers or acrylate monomers and a desired (meth)acrylate resin can be obtained by changing the kind of a monomer or composition ratio of monomers. The (meth)acrylate monomer may be copolymerized with copolymerizable unsaturated monomers other than the (meth)acrylate monomer or may be blended with other resins.

Examples of a monomer forming a (meth)acrylate resin include (meth)acrylic acid, methyl(meth)acrylate, ethyl(meth)acrylate, propyl(meth)acrylate, butyl(meth)acrylate, isopropyl(meth)acrylate, isobutyl(meth)acrylate, t-butyl(meth)acrylate, stearyl(meth)acrylate, 2-hydroxy(meth)acrylate, acetoacetoxyethyl(meth)acrylate, dimethylaminoethyl(meth)acrylate, 2-hydroxypropyl(meth)acrylate, di(ethylene glycol) ethyl ether(meth)acrylate, ethylene glycol methyl ether (meth)acrylate, isobonyl(meth)acrylate, chloroethyltrimethylammonium(meth)acrylate, trifluoroethyl(meth)acrylate, octafluoropentyl(meth)acrylate, 2-acetoamidomethyl(meth)acrylate, 2-methoxyethyl(meth)acrylate, 2-dimethylaminoethyl(meth)acrylate, 3-trimethoxysilanepropyl(meth)acrylate, benzyl(meth)acrylate, tridecyl(meth)acrylate, 4-hydroxybutyl(meth)acrylate, tetrahydrofuryl(meth)acrylate, dodecyl(meth)acrylate, octadecyl(meth)acrylate, 2-diethylaminoethyl(meth)acrylate, 2-ethylhexyl(meth)acrylate, cyclohexyl(meth)acrylate, phenyl(meth)acrylate, and glycidyl(meth)acrylate. Of these, (meth)acrylic acid, methyl(meth)acrylate, ethyl(meth)acrylate, propyl(meth)acrylate, butyl(meth)acrylate, stearyl(meth)acrylate, 2-hyroxyethyl(meth)acrylate, acetoacetoxyethyl(meth)acrylate, benzyl(meth)acrylate, tridecyl(meth)acrylate, dodecyl(meth)acrylate, and 2-ethylhexyl(meth)acrylate are preferred.

Polystyrene resins include a styrene homopolymer, and a random copolymer, block copolymer and graft copolymer obtained by copolymerization of a styrene monomer with other copolymerizable unsaturated monomers. A blend of such a styrene polymer and other polymers, or a polymer alloy is also usable.

Examples of a styrene monomer to form a polystyrene resins include styrene, an nuclear alkyl-substituted styrene such as α-methylstyrene, α-ethylstyrene, α-methylstyrene-p-methylstyrene, o-methylstyrene, m-methylstyrene, or p-methylstyrene; and a nuclear halogen-substituted styrene such as o-chlorostyrene, m-chlorostyrene, p-chlorostyrene, p-bromostyrene, trichlorostyrene, and tribromostyrene. Of these, styrene or α-methylstyrene is preferred.

Examples of the dye medium resins include a copolymer resin of a copolymer resin of benzylmethacrylate/ethyl acrylate or butyl acrylate, a copolymer resin of methyl methacrylate/2-ethylhexyl methacrylate, copolymer resin of methyl methacrylate/methacrylic acid/stearyl methacrylate/acetoacetoxyethyl methacrylate, copolymer resin of styrene/acetoacetoxyethyl methacrylate/stearyl methacrylate, copolymer resin of styrene/2-hydroxyethyl methacrylate/stearyl methacrylate, and copolymer resin of 2-ethylhexyl methacrylate/2-hydroxyethyl methacrylate.

The number-average molecular weight of the dye medium resin is preferably from 500 to 100,000, and more preferably from 1,000 to 30,000 in terms of durability and minute particle-forming ability.

### Surfactant

The minute colored particles may contain a surfactant, and in this instance, examples of the surfactant include an anionic surfactant and/or nonionic surfactant and/or a reactive surfactant which may be conventionally used.

Examples of the nonionic surfactants include polyoxyethylene alkyl ethers such as polyoxyethylene lauryl ether and polyoxyethylene stearyl ether; polyoxyethylene alkylphenyl ethers such as polyoxyethylene nonylphenyl ether; sorbitan higher fatty acid esters such as sorbitan monolaurate, sorbitan monostearate, and sorbitan trioleate; polyoxyethylene sorbitan higher fatty acid esters, such as polyoxyethylene sorbitan monolaurate; polyoxyethylene higher fatty acid esters such as polyoxyethylene monolaurate and polyoxyethylene monostearate; glycerin higher fatty acid esters such as oleic acid monoglyceride and stearic acid monoglyceride; and polyoxyethylene-polyoxypropylene block copolymer.

Examples of conventional anionic surfactants include higher fatty acid salts such as sodium oleate, alkylarylsulfonates such as sodium dodecylbenzenesulfonate, alkyl sulfuric acid esters such as sodium laurylsulfate, polyoxyethylene alkyl ether sulfuric acid ester salts such as polyethoxyethylene lauryl ether sulfuric acid sodium salt, polyoxyethylene alkylaryl ether sulfuric acid esters such as polyoxyethylene nonylphenyl ether sulfuric acid sodium salt, alkyl sulfosuccinic acid ester salts such as monooctyl sulfosuccinic acid sodium salt, dioctyl sulfosuccinic acid sodium salt, and polyoxyethylene lauryl sulfosuccinic acid sodium salt, and derivatives of the foregoing.

Reactive surfactants include anionic or nonionic ones but compounds containing the following substituent A, B or C:

A: straight chain or branched alkyl, or substituted or unsubstituted aromatic group having at least 6 carbon atoms,

B: nonionic or anionic substituent expressing surface-activity, and

C: radical-polymerizable group.

Example of a straight chain alkyl group described in the foregoing substituent A include heptyl, octyl, nonyl and decyl; example of a branched alkyl group include 2-ethylhexyl; and example of an aromatic group include phenyl, nonylphenyl and naphthyl.

Example of a nonionic substituent expressing surface-activity (emulsifying capability), described in the foregoing B include polyethylene oxide, polypropylene oxide and their copolymer polyalkylene oxide. Example of an anionic substituent include a carboxylic acid, phosphoric acid, sulfonic acid and their salts. An anionic group which substitutes the terminal end of an alkylene oxide, is a specific example of the foregoing anionic substituent. The substituent of the foregoing B is preferably an anionic group, and more preferably one which forms a salt at the terminal end.

The radical-polymerizable group is a group capable of undergoing radical polymerization or a group capable of causing polymerization or cross-linking reaction via a radical active species. Examples thereof include groups containing an ethylenically unsaturated bond, such as a vinyl group, allyl group, 1-propenyl group, isopropenyl group, acryl group, methacryl group, maleimide group, acrylamide group or styryl group.

### (Toner Binder Resins)

It is preferable to employ thermoplastic resins capable of realizing a close contact among the minute colored particles, and those which are solvent-soluble are particularly preferred. Further, when those precursors are solvent-soluble, it is possible to employ them even though they are hardening resins forming a three-dimensional structure. It is preferable to employ those upon considering that the resulting toner exhibits desired electrification properties and fixability, other than the above conditions.

Employed as such toner binder resins may be those including a toner binder resin without particular limitation. Specific examples include styrene based resins, acryl based resins such as alkyl acrylate or alkyl methacrylate, styrene-acryl based copolymers, polyester resins, silicone resins, olefin based resins, amide resins, and epoxy resins. Of these, in order to enhance transparency and color reproduction of superimposed images, preferably listed are styrene based resins, acryl based resins, styrene-acryl based resins, and polyester resins which exhibit high transparency, as well as exhibit low viscosity when melted and desired sharp melt properties, and further, these styrene-acryl resins are preferred which particularly exhibit high targeted effects. These resins may be employed individually or in combinations of at least two types.

Further, when toner particles constituting the toner of the present invention are produced employing a suspension polymerization method, an emulsion polymerization method, or an emulsion polymerization aggregation method, employed as polymerizable monomers may, for example, be styrene monomers such as styrene, methylstyrene, methoxystyrene, butylstyrene, phenylstyrene, or chlorostyrene; (meth)acrylate ester based monomers such as methyl(meth)acrylate, ethyl(meth)acrylate, butyl(meth)acrylate, or ethylhexyl(meth)acrylate; and carboxylic acid based monomers such as acrylic acid or fumaric acid. These may be employed singly or in combinations of at least two types.

As for the toner binding resin, the number-average molecular weight (Mn) is preferably from 3000 to 6000, and more preferably from 3500 to 5500. The ratio of the weight-average molecular weight (Mw) to the number-average molecular weight (Mn), that is Mw/Mn, is preferably from 2 to 6, and more preferably 2.5 to 5.5. The glass transition temperature (Tg) is preferably from 50 to 70° C. and more preferably from 55 to 70° C. The softening temperature is preferably from 90 to 110° C., and more preferably from 90 to 105° C.

When the number average molecular weight of toner binder resins is at most 3,000, the folding fixability of the resulting toner is degraded. For example, when a solid full-color image is folded, it is a concern that the image is peeled off resulting in the lack of the image. On the other hand, when it is at least 6,000, it is a concern that the resulting toner exhibits insufficient fixing strength due to poor heat melting properties during the fixing process. Further, when Mw/Mn of toner binder resins is at most 2, high temperature offset phenomena tend to occur during the fixing process. On the other hand, when Mw/Mn is at least 6, sharp melt characteristics during the fixing process are degraded whereby the resulting toner exhibits neither sufficient light transmission nor desired color reproduction in the resulting full-color images due to insufficient color mixing capability. Further, when the glass transition temperature of toner binder resins is at most 50° C., the resulting toner does not exhibit sufficient heat resistance, whereby toner particles tend to aggregate during storage. On the other hand, when it is at least 70° C., the resulting toner does not readily melt to result in insufficient fixing and does not exhibit sufficient color mixing capability whereby the resulting full-color image results in insufficient color reproduction. Still further, when the softening point is at most 90° C., high temperature offset tends to occur during the fixing process, while when it is at least 110° C., it is not possible to achieve sufficient fixing strength, sufficient light transmittance, nor sufficient color mixing capability, and further, glossiness of the resulting full-color images is degraded.

The volume average particle diameter of toner binder resin particles, prepared in the minute toner binder resin SDrWiFOH SROyPHrizDWiRn SrRFHss, is SrHIHrDEOy RI 30-500 nm.

### (Chain Transfer Agents)

When toner particles constituting the toner of the present invention are produced employing an emulsion polymerization aggregation process, in order to regulate the molecular weight of toner binder resins, it is possible to employ commonly used chain transfer agents. The chain transfer agents are not particularly limited and examples include mercaptans such as 2-chloroethanol, octylmercaptan, dodecylmercaptan or t-dodecylmercaptan, and styrene dimers.

### (Polymerization Initiators)

When toner particles, which constitute the toner of the present invention, are produced employing a suspension polymerization method, an emulsion polymerization method, or an emulsion polymerization aggregation method, employed as polymerization initiators may be any of the appropriate ones as long as they are water-soluble polymerization initiators. Specific examples of polymerizations initiators include persulfates (potassium persulfate and ammonium persulfate), DzR EDsHd FRPSRunds (4,4′-DzREis-4-FyDnRvDOHriF DFid Dnd sDOWs WhHrHRI) Dnd 2,2′-DzREis(2-DPidinRSrRSDnH) sDOWs, Dnd peroxide compounds.

### (Surfactants)

Employed as surfactants which are used to produce the toner particles, which constitute the toner of the present invention employing a suspension polymerization method, an emulsion polymerizations method, or an emulsion polymerization aggregation method may be various conventional ionic and nonionic surfactants.

xAggregating Agentsz

Listed as aggregating agents, which are employed when toner particles which constitute the toner of the present invention are produced employing an emulsion polymerization aggregation method, may, for example, be alkaline metal salts and alkaline earth metal salts. Listed as alkaline metals constituting aggregating agents are lithium, potassium, and sodium, while listed as alkaline earth metals constituting aggregating agents are magnesium, potassium, strontium, and barium. Or these, preferred are potassium, sodium, magnesium, calcium, and barium. Listed as counter ions of the above alkaline metals or alkaline earth metals are chloride ions, bromide ions, iodide ions, carbonate ions, and sulfate ions.

### Off-Set Presenting Agent

Off-set preventing agents usable in this invention are not specifically limited and specific examples thereof include polyethylene wax, oxidation type polyethylene wax, polypropylene wax, oxidation type polypropylene wax, carnauba wax, SaASOi wax, rice wax, candelilla wax, jojoba wax, and bees wax.

Such a wax is used preferably in an amount of 0.5 to 5.0 parts by weight per 100 parts by weight of thermoplastic resin, and more preferably 1.0 to 3.0 parts by weight. Incorporation of an off-set preventing agent within the foregoing range displays its effects, resulting in superior light-transmittance and color reproduction.

Listed as methods, which incorporate offset preventing agents into toner particles, are a method in which in salting-out, aggregation and fusion processes which form toner particles, a dispersion (being a wax emulsion) of offset preventing agent particles is added, whereby minute toner binder resin particles, minute colorant particles, and offset preventing agent particles are salted out, aggregated, and fused, and another method in which in salting-out, aggregation and fusion processes which form toner particles, minute toner binder resin particles incorporating offset preventing agents and minute colorant particles are salted out, aggregated, and fused. These methods may be combined.

The content of offset preventing agents in toner SDrWiFOHs is WR EH FRPPRnOy 0.5-5 SDrWs Ey wHiJhW wiWh respect to 100 parts by weight of the toner forming binder rHsins, EuW is WR EH SrHIHrDEOy 1-3 SDrWs Ey wHiJhW. :hHn the content of offset preventing agents is at most 0.5 part by weight with respect to 100 parts by weight of the toner particle forming binder resins, it is not possible to result in sufficient offset preventing effects, while when it is at least 5 parts with respect to 100 parts by weight of toner particle forming binder resins, the resulting light transmittance and color reproduction are degraded.

### Charge Control Agent

A charge control agent may be incorporated in the toner particles composing the toner of this invention. The charge control agent is not specifically limited and includes various materials giving positive or negative charge via frictional electrification. As a negative charge control agent used for color toners are usable colorless, white or light color charge control agents.

The example of the negative charge control agent used for the toner particles composed of color toner includes colorless, white or pale color charge control agent. Preferred example thereof includes a metal complex (salicylic acid metal complex) such as zinc or chromium metal complex of salicylic acid derivatives, calixarene compounds, organic boron compounds, and fluorine-containing quaternary ammonium salt compounds. There are usable salicylic acid metal complexes described, for example, in JP-A Nos. 53-127726 and 62-145255; calixarene compounds described, for example, in JP-A No. 2-201378; organic boron compounds described, for example, in JP-A Nos. 2-221967 and 3-1162.

Such a charge control agent is used preferably in an amount of 0.1 to 10 parts by weight per 100 parts by weight of toner binder resin, and more preferably 0.5 to 5.0 parts by weight.

### Particle Size of the Toner Particles

The volume-average particle size of the toner relating to this invention is preferably 4-10 μm and more preferably 6-9 μm. The average particle size can be controlled by concentration of coagulating agent (salting agent) or adding amount of a solvent to be employed, and period for fusing or component of the polymer when the toner is prepared by, for example, an emulsion polymerization aggregation method.

The above mentioned average particle size gives enhanced transfer efficiency to improve half-tone image quality and improved image quality of fine line, dot and so on.

The volume-average particle size of the toner is measured by Coulter Counter TA-II or Coulter Multisizer produced by Coulter Corp.). In the invention, the number average diameter of the toner particles are measured and calculated by employing Coulter Multisizer connected to a personal computer through an interface for outputting the particle diameter distribution, manufactured by Nikkaki Co., itd. The volume and the number of particles were calculated by measuring the number distribution of toner having a diameter of 2 μm or more (for example 2-40 μm) by the use of an aperture of 100 μm in the Coulter Multisizer

### External Additive

In this invention, the thus prepared toner particles may be used as it is, however, the toner of the invention may be composed by incorporating an external additive, so-called post treating agent, such as a fluidizer or a cleaning aid, to the toner particles to improve fluidity, electrostatic charge or cleaning ability.

Examples of such post treating agent include inorganic oxide particles such as particulate silica, particulate alumina, and particulate titania, inorganic stearate compound particles such particulate aluminum stearate or particulate zinc stearate, and inorganic titanate compound particles such as strontium titanate or zinc titanate. These additives may be used singly or in combination. These particles are desirably used together with a surface treatment of a silane coupling agent, titan coupling agent, higher fatty acid or silicone oil for the purpose of environmental resistance stability and heat resistance maintenance.

The external additive is incorporated preferably in an amount of 0.05 to 5 parts by weight per 100 parts by weight of toner particles, and more preferably from 0.1 to 3 parts by weight.

### Developer

The toner of this invention may be used as a magnetic or non magnetic single-component developer, or may be used for a two-component developer by mixed with a carrier.

Conventional carriers used for a two-component developer can be used in combination with the toner of this invention. There can be used, for example, a carrier composed of magnetic material particles such as iron or ferrite, a resin-coated carrier formed by covering magnetic material particles with resin and a binder type carrier obtained by dispersing powdery magnetic material in a binder.

Examples of the coating resin composing coated carrier are not restricted particularly, but include olefin resin, styrene resin, styrene-acryl resin, silicon resin, ester resin and fluorinated resin. Examples of the binder resin composed of the binder type carrier are not particularly restricted, but include known resins such as styrene-acryl resin, polyester resin, fluorinated resin and phenol resin.

The volume-average particle size of a carrier is preferably 15 to 100 μm to obtain high image quality and prevent a carrier from fogging. The volume-average particle size of the carrier can be determined using a laser diffraction type particle size distribution measurement apparatus, HEiOS (produced by Sympatec dmbH).

For the preferable carriers, the use of a resin-coated carrier using silicone resin, copolymer resin (graft resin) of an organopolysioxane and a vinyl monomer or polyester resin is preferred from the viewpoint of toner spent and the like. Specifically, a carrier coated with a resin which is obtained by reacting isocyanate with a copolymer resin of an organopolysiloxane and a vinyl monomer, is preferred in terms of fastness, ecological concerns and resistance to spent toner. A monomer containing a substituent such as a hydroxyl group having reactivity with an isocyanate needs to be used as the above-described vinyl monomer.

### Image Forming Method

The toner of the invention is suitably used for an electrophotographic image forming method.

This image forming method includes at least a developing process developing an electrostatic charge image formed on an electrostatic charge image carrier by a toner and a transfer process transferring the toner image formed by the developing process to image recording media.

In this invention, the system of image formation is not specifically limited. Examples thereof include a batch transfer system in which plural images are formed on a photoreceptor and transferred all together, a system in which an image formed on a photoreceptor is successively transferred using a transfer belt and is not specifically limited to such, of which the system in which plural images are formed on a photoreceptor and transferred all together is preferred.

The operation for forming full color image by, for example, a batch transfer method is described below.

In this system, the photoreceptor is uniformly charged and the first toner (yellow) image is formed by the first development after the first exposing according to the first (yellow) image information among color separated four images of yellow, magenta cyan and back on the photoreceptor. Subsequently, the photoreceptor having formed the yellow toner image is uniformly charged, exposed according to the second (magenta) image and the second development is performed to the second toner image. Further, the photoreceptor having formed the first and second toner images is uniformly charged, exposed according to the third (cyan) image and the third development is performed to form the third toner image on the photoreceptor. Furthermore, the photoreceptor having formed the first, second and third toner images is uniformly charged, exposed according to the fourth (black) image and the fourth development is performed to form the fourth toner image on the photoreceptor. In the foregoing, the first development is performed with a yellow toner, the second development is performed with a magenta toner, the third development is performed with a cyan toner and the fourth development is performed with a black toner to form a full color image. Thereafter, images formed on the photoreceptor are transferred all together to a transfer material such as paper and fixed on the transfer material to form images. In this system, images formed on the photoreceptor are transferred all together to paper or the like to form the final image, so that differing from a so-called intermediate system, the transfer, which often perturbs the previous images, is done only one time, resulting in enhanced image quality.

Since a plural number of development processes need to be performed to develop latent images formed on the photoreceptor, a non-contact development system is preferred. A system in which an alternate electric field is applied during development, is also preferable.

Suitable fixing systems usable in this invention include a so-called contact heating system. Representative examples of the contact heating system include a heat roll fixing system and a pressure heat-fixing system in which fixing is performed using a rolling pressure member including a fixed heating body.

In the image formation process to perform development, transfer and fixing by using a toner of this invention, the toner transferred onto a transfer material, e.g., paper, adheres onto the paper surface without minute colored particles being disintegrated, even after fixing.

The above heat roller fixing system is composed of an upper roller composed of an iron or aluminum cylinder covered with tetrafluoroethylene or polytetrafluoroethylene-perfluoroalkoxyvinyl ether copolymers, including a heating source in the interior of the above metal cylinder, and a lower roller formed of silicone rubber. More specifically, the heating source carries a linear heater which raises the WHPSHrDWurH RI WhH surIDFH R WhH uSSHr rROOHr RI 120-200° C. In the fixing section, pressure is applied between the upper and lower rollers so that the lower roller is deformed to create a so-called nip. The width of the nip is commonly 1-10 PP, EuW is SrHIHrDEOy 1.5-7 PP. 7hH OinHDr IixinJ rDWH is SrHIHrDEOy 40-600 PP/sHFRnd. :hHn WhH niS width is narrow, it becomes impossible to provide uniformly heat onto the toner, resulting in uneven fixing. On the other hand, when the nip is wide, melting resin is accelerated to result in problems in which fixing offset becomes excessive.

If appropriate, fixing cleaning mechanisms may be provided. In such a case, it is possible to employ a system in which silicone oil is provided on a upper fixing roller or on the film, or a method in which cleaning is carried out employing a padded roller web, impregnated with silicone oil. Employed as examples of such silicone oil are those which exhibit high heat resistance, and polydimethylsiloxane, polymethylsiloxane, polydiphenylsiloxane, and fluorine-containing polysiloxane are employed. Those of low viscosity result in an increase of runoff, whereby those of a viscosity RI 1,000-100,000 FS DW 20° C. DrH SrHIHrDEOy HPSORyHd.

In the above toner, dyes as a colorant are dispersed into toner particles in the form of minute colored particles and further, volume average particle diameter D1 of the minute colored particles and the average diameter D2 of the dye cloud formed by the dyes are controlled to satisfy the specified relational formula, whereby sufficient transparency and chroma, as well as desired color reproduction and excellent electrification characteristics are realized while resulting in sufficient heat and offset resistance. As a result, the quality of images formed by the above electrostatic developing toner is retained for a long period of time.

Further, since minute colored particles at a relatively small diameter are monodispersed into toner binder resins, dyes are dispersed in the toner binder resins at the molecular level, whereby it is possible to significantly decrease the presence of components such as shielding particles which shield light in the toner particle and subsequently, it is possible to further enhance transparency of single colors as well as superimposed colors.

By employing the toner as described above, dyes are neither released nor exposed (nor allowed to migrate) onto the surface of toner particles, whereby problems do not occur such as a low charge amount which occurs in the use of toner employing common dyes, high ambient dependence such as a large difference in the charge amount between the high temperature and high humidity, and the low temperature and low humidity, and the fluctuation of the charge amount due to the type of colorants such as each of cyan, magenta, yellow, and black toners. Consequently, in the resulting toner, electrification characteristics among toner particles become substantially uniform, whereby excellent image characteristics are realized in formed images.

Further, dyes are not in a molecular state, but are in the form of lumps in which some molecules are aggregated, whereby migration of the above dyes is retarded, resulting in no problems such as dye sublimation and oil staining in the fixing process employing thermal fixing.

### EXAMPLE

The embodiment of the present invention is described in terms of examples.

### Preparation of Minute Colored Particle Dispersion 1

To a separable flask were added 13.5 g of polymer (P-1), a 50/30/20 mixture of methylmethacrylate (MMA)/acetoxyethylmethacrylate (AAEM)/stearylmethacrylate (SMA), 16.0 g of dye (A-1) shown below and 123.5 of acetic acetate and after the atmosphere in interior was replaced with nitrogen gas, the dye was completely dissolved with stirring. Further thereto, 230 g of an aqueous solution 8.0 g of AnrAiON hH-50 (a surfactant, produced by DAI-ICHI hOdvO SEIvAhr CO., iTD.) was dropwise added with stirring and then emulsified for 300 sec. using CiEAR-MIu W-MOTION CiM-0.8W (produced by M-TECHNInrE Co.). Thereafter, acetic acetate was removed under reduced pressure to obtain the minute colored particle dispersion 1 containing a dye. In the thus obtained dispersion, the volume-average particle size of colored particles was 30 nm. Hereinafter, the volume-average particle size was determined using wETASIwER (Malvern Instruments).

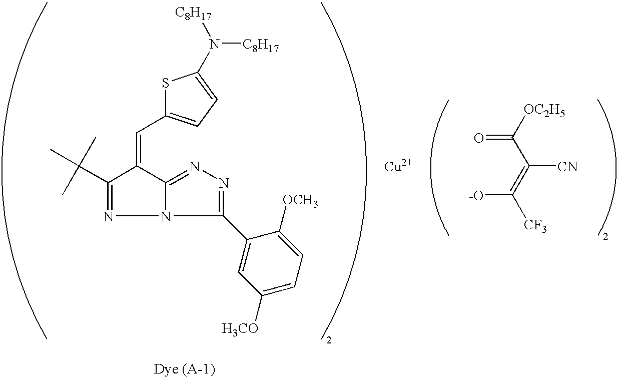

### Preparation of Minute Colored Particle Dispersion 2

Further to the minute colored particle dispersion 1, in whiFh dyH DrH iPSrHJnDWHd Dnd SrHSDrHd Ey WhH “3rHSDrDWiRn RI 0inuWH CRORrHd 3DrWiFOH DisSHrsiRn 1”, 0.5 J RI SRWDssiuP persulfate was added and heated at 70° C. using a heated and 10.0 g of methyl methacrylate was dropwise added and allowed to react for 5 hr. The thus dispersion of colored particle 2 having core-shell type colored particles was obtained. In the thus obtained dispersion, the volume-average particle size of colored particles was 33 nm.

### Preparation of Minute Colored Particle Dispersion 3

The above mentioned dye (A-1) in an amount of 18.0 g was dissolved in 720.0 g of ethyl acetate, and after the atmosphere in interior was replaced with nitrogen gas, the dye was completely dissolved with stirring. Further thereto, 1,200 g of an aqueous solution 5.94 g of EMAi-27C (a surfactant, produced by hao Corporation) was dropwise added with stirring and then emulsified for 300 sec. using CiEAR-MIu W-MOTION CiM-0.8W (produced by M-TECHNInrE Co.). Thereafter, acetic acetate was removed under reduced pressure to obtain minute colored particle dispersion 3 containing a dye. In the thus obtained dispersion, the volume-average particle size of colored particles was 56 nm.

### Preparation of Minute Colored Particle Dispersion 4

A minute colored particle dispersion 4 was prepared similarly to the foregoing minute colored particle dispersion 1, provided that the polymer (P-1) and the dye (A-1) were replaced by polymer (P-2), a 30/40/30 mixture of styrene (ST)/2-hydroxyethylmethacrylate (HEMA)/stearyl methacrylate (SMA), and dye (A-2), respectively. In the thus obtained dispersion, the volume-average particle size of colored particle was 45 nm.

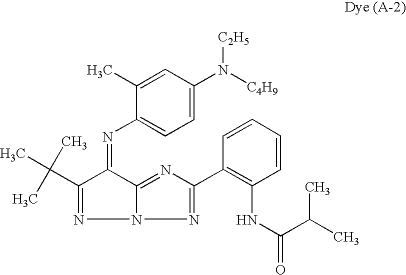

### Preparation of Minute Colored Particle Dispersion 5

A minute colored particle dispersion 5 was prepared similarly to the foregoing minute colored particle dispersion 3, provided that the dye (A-1) was replaced by dye (A-3), respectively. In the thus obtained dispersion, the volume-average particle size of colored particles was 480 nm.

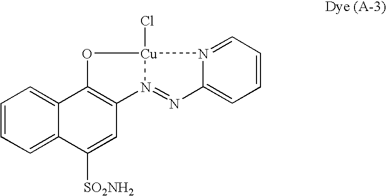

### Preparation of Minute Colored Particle Dispersion 6

A minute colored particle dispersion 6 was prepared similarly to the foregoing minute colored particle dispersion 3, provided that the dye (A-1) was replaced by dye (A-4). In the thus obtained dispersion, the volume-average particle size of colored particles was 38 nm.

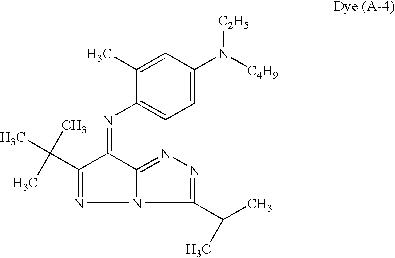

### Preparation of Minute Colored Particle Dispersion 7

A minute colored particle dispersion 7 was prepared similarly to the foregoing minute colored particle dispersion 2, provided that the dye (A-1) was replaced by dye (A-3), and the amount of the methacrylate was changed to 100.0 g. In the thus obtained dispersion, the volume-average particle size of colored particles was 189 nm.

### Preparation of Minute Colored Particle Dispersion 8

A dispersion of core/shell type minute colored particle 8, having volume average particle size of 1560 nm, was prepared similarly to the foregoing dispersion of Minute colored particle 3, provided that C.I. Pigment Red 123, pigment (P) shown below, was used in place of the dye (A).

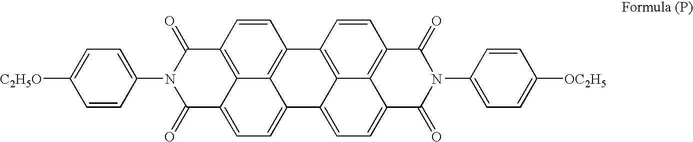

### Measurement SP Value

The SP value in (cal/cm³)^{1/2} of the contained minute colored particles of the colored particle dispersions 1-8 was calculated by employing a molecule calculation package, named CAChe, produced by FrJITSr, which is based a fragment method described in A. h. dhost et al., J. Comput. Chem. 9: 80 (1988). The result is shown in Table 1.

### Preparation of Dispersion of Colored Particles 1

Into 5,000 ml separable flask fitted with a stirring device, a temperature sensor, a condenser and a nitrogen-introducing was charged an aqueous surfactant solution (aqueous medium) of 7.08 g of an anionic surfactant (sodium dodecylbenzenesulfonate) which was previously dissolved in 2760 g of deionized water and the internal temperature was increased with stirring at a stirring rate of 230 rpm under a stream of nitrogen. Separately, 72.0 g of a compound of the following Formula (C) as releasing agent was added to a monomer mixture of 115.1 g of styrene, 42.0 g of n-butyl acrylate and 10.9 g of methacrylic acid and dissolved with heating at 80° C. to prepare a monomer solution. Using a mechanical disperser having a circulation path, the monomer solution (80° C.) was mixed with the foregoing aqueous surfactant solution (80° C.) and stirred to prepare a dispersion of emulsion particles (oil droplets) having a uniform dispersion particle size. Subsequently, to this dispersion, a polymerization initiator solution of 0.84 g of a polymerization initiator (potassium persulfate, hPS) dissolved in 200 g of deionized water was added and heated at 80° C. for 3 hr. with stirring to perform polymerization (first polymerization) to form a latex. Then, to this latex, a polymerization solution of 7.73 g of a polymerization initiator (hPS) dissolved in 240 g of deionized water was added. After 15 min, a monomer mixture of 383.6 g of styrene, 140.0 g of n-butyl acrylate, 36.4 g of methacrylic acid and 13.7 g of tert-dodecylmercaptan was added dropwise at 80° C. over a period of 126 min. After completing addition, stirring continued for 60 min. with heating to perform polymerization (second polymerization). Then the reaction mixture was cooled to 40° C. to obtain latex. The thus obtained latex was designated as latex (B). The SP value of the obtained latex (B) was 8.7 (cal/cm³)^{1/2} measured in the same way as the colored particles of the dispersion of the minute colored particle.

C{CH₂OCO(CH₂)₂₀CH₃}₄ Formula C:

### Preparation Example of Toner 1

Into 5 lit. separable flask fitted with a stirring device, a temperature sensor, a condenser and a nitrogen-introducing was charged 1250 g of the latex (B), 2,000 ml of deionized water and the minute colored particle dispersion 1. After adjusting t interior temperature to 30° C., the reaction mixture was adjusted to a pH 10.0 by adding a 5N aqueous sodium hydroxide solution. Then, an aqueous solution of 52.6 g of magnesium chloride hexahydride which was previously dissolved in 72 ml of deionized water, was added at 30° C. in 10 min. After allowed to stand for 3 min., heating was started and the reaction system was heated to 90° C. in 6 min. (at a temperature-increasing rate of 10° C./min). From that state, measurement of the aggregated particle size was started using Coulter Counter TA-II (produced by Coulter Corp.). When the volume-average particle size reached 6.5 μm, an aqueous solution of sodium chloride of 115 g dissolved in 700 ml of deionized water to stop grain growth and the reaction mixture was further stirred for 6 hr. with maintaining the temperature at 90-2° C. to continue fusion. Thereafter, the reaction mixture was cooled to 30° C. at a rate of 6° C./min. The aggregated particles were filtered off from dispersion of the aggregated particles and dispersed in deionized water having pH of 3 in an amount of 10 times the weight of aggregated particles to perform washing. After repeating the procedure of washing and filtration twice, washing was done with deionized water and drying was done by hot air at 40° C. to obtain toner particles, which was denoted Ds “7RnHr 3DrWiFOHs 1”. 7R WhH 7RnHr 3DrWiFOHs 1, hydrophobic silica (having a number-average particle size of 12 nm and a hydrophobicity degree of 68) and hydrophobic titanium (having a number-average particle size of 20 nm and a hydrophobicity degree of 63) as external additives were added at lB by weight and 1.2B by weight, respectively and mixed for 15 min. using a Henschel mixer Produced by Mitsui Miike hako-sha). Thereafter, coarse particles were removed using a sieve having an opening of 45 μm to obtain Toner 1.

The shape and particle size were not changed between the Toner Particles 1 and Toner 1.

### Preparation Example of Toner 2

Toner particles were prepared similarly to the foregoing Toner Particle 1, except that the minute colored particle dispersion 1 was replaced by the minute colored particle dispersion 2. The thus obtained toner particles wFrH dHsiJnDWHd “7RnFr 2”.

### Preparation Example of Toner 3

Toner particles were prepared similarly to the foregoing toner particle 1, except that the minute colored particle dispersion 1 was replaced by the minute colored particle dispersion 3. The thus obtained toner particles wHrH dHsiJnDWHd “7RnHr 3”.

### Preparation Example of Toner 4

Toner particles were prepared similarly to the foregoing toner particle 1, except that the minute colored particle dispersion 1 was replaced by the minute colored particle dispersion 4. The thus obtained toner particles wHrH dHsiJnDWHd “7RnHr 4”.

### Preparation Example of Toner 5

Toner particles were prepared similarly to the foregoing toner particle 1, except that the minute colored particle dispersion 1 was replaced by the minute colored particle dispersion 5. The thus obtained toner particles wHrH dHsiJnDWHd “7RnHr 5”.

### Preparation Example of Comparative Toner 1

Toner particles were prepared similarly to the foregoing toner particle 1, except that the minute colored particle dispersion 1 was replaced by the minute colored particle dispersion 6. The thus obtained toner particles wHrH dHsiJnDWHd “CRPSDrDWivH 7RnHr 1”.

In this Comparative Toner 1 the colored particle does not contain an anti-oxidant but is composed of dye only.

### Preparation Example of Comparative Toner 2

Toner particles were prepared similarly to the foregoing toner particle 1, except that the minute colored particle dispersion 1 was replaced by the minute colored particle dispersion 7. The thus obtained toner particles wHrH dHsiJnDWHd “CRPSDrDWivH 7RnHr 2”.

The Comparative Toner 2 contains an anti-oxidant but not in the colored particle.

### Preparation Example of Comparative Toner 3

Toner particles were prepared similarly to the foregoing toner particle 1, except that the minute colored particle dispersion 1 was replaced by the minute colored particle dispersion 8. The thus obtained toner particles wHrH dHsiJnDWHd “CRPSDrDWivH 7RnHr 3”.

The Comparative Toner 3 contains a dye and an anti-oxidant in the colored particle in a dissolved state.

### Measurement of Diameter of Dye Cloud D2

The average diameter of D2 of the dye cloud of the colored particles was measured for each of the toner samples 1-5 and comparative toner samples 1-5 in such a manner that a toner particle was cut to a thickness of 0.2 μm, employing a microtome. The resulting sample was employed to form a transmission electron microscope image (being a TEM image) at a magnification factor of 100,000, then the arithmetical average value in the Fere direction of 100 dye clouds was designated as the average diameter D2 of the dye cloud.

TABLE 1

| | Minute colored particle | | | | | | |
|---|---|---|---|---|---|---|---|
| | | solume | | | SP salue | Average | |
| | | average | Colorant | | of toner | diameter | |
| | Minute | particle | Species C SP | | binder | of dye | |
| Toner | colored | diameter | salue | | resin | cloud D2 | |
| No. | particle No. | D1 (nm) | (cal/cm³)^{1/2} | | (cal/cm³)^{1/2} | (nm) | D2/D1 |
| Toner 1 | 1 | 30 | A-1 | 8.9 | 8.7 | 51 | 1.70 |
| Toner 2 | 2 | 33 | A-1 | 8.7 | 8.7 | 38 | 1.15 |
| Toner 3 | 3 | 56 | A-1 | 8.9 | 8.7 | 129 | 2.30 |
| Toner 4 | 4 | 45 | A-2 | 10.3 | 8.7 | 87 | 1.94 |
| Toner 5 | 5 | 480 | A-3 | 12.8 | 8.7 | 499 | 1.04 |
| Comp. | 6 | 38 | A-4 | 9.6 | 8.7 | 186 | 4.90 |
| Toner 1 | | | | | | | |
| Comp. | 7 | 189 | A-3 | 12.8 | 8.7 | 181 | 0.96 |
| Toner 2 | | | | | | | |
| Comp. | 8 | 156 | Pigment | 11.7 | 8.7 | 155 | 0.99 |
| Toner 3 | | | | | | | |

### Preparation of Developers

A silicone resin-covered ferrite carrier having a volume-average particle size of 60 μm was mixed with each of the foregoing toners 1-5 and comparative toners 1-3 at a WRnHR FRnWHnW RI 6% Ey wHiJhW WR REWDin “DHvHORSHr 1” WR “DHvHORSHr 5” Dnd “CRPSDrDWivH dHvHORSHr 1” WR “FRPSDrDWivH dHvHORSHr 3”.

### Examples 1-5 and Comparative Examples 1-3

The following tests (1) to (4) were conducted by employing honica 7075 (produced by honica Minolta Business Technology, Inc.) as an apparatus, and the Developers 1-5 and the Comparative Developers 1-3 for plain paper and OHP sheet, in which a fixing device was modified as below. Evaluation was made under an environment of ordinary temperature and ordinary humidity (25° C., 55B RH). The results are shown in Table 2.

The development conditions were set as follows:
Photoreceptor surface potential: −700 s
DC bias: −500 s
Dsd (distance between photoreceptor and development sleeve): 600 μm
Developer layer control: magnet type (H-Cut system)
Developer layer thickness: 700 μm
Development sleeve: 40 mm.

A heat-roll fixing system was used as a fixing device. Thus, a heating roller was formed by covering the core surface of an aluminum alloy cylinder (having an inside diameter of 40 mm, a thickness of 1.0 mm and a total width of 310 mm) including a heater in the central portion, using a 120 μm thick tube of copolymer of tetrafluoroethylene and perfluoroalkyl vinyl ether (PFA). A pressure roller was formed by covering the core surface of an iron cylinder (having an inside diameter of 40 mm and a thickness of 2.0 mm), using a sponge-form silicone rubber (having an AShER C hardness of 48 and a thickness of 2 mm). The heating roller was brought into contact with the pressure roller to form a 5.5 mm wide nip with pressure load of 150 N. Using this fixing apparatus, the print speed was set to 480 mm/sec. A supply system in which a web system was impregnated with polydiphenylsilicone (exhibiting a viscosity of 10 Pa·s at 20° C.), was employed as a cleaning mechanism of the fixing device. The fixing temperature was controlled based on the surface temperature of the heating roller was controlled at temperature of 175° C. The coating amount of silicone oil was 0.1 mg per A4 size sheet.

### (1) Transparency

A transparent image formed on an OHP sheet, having toner density of 7.0-0.05 mg/cm² was prepared and the fixed image was measured with respect to visible spectral absorbance by Type 330 Spectrophotometer (produced by HITACHI) using an OHP sheet having no toner as a reference. There were determined the difference in absorbance between 650 nm and 450 nm of a yellow toner, the difference in absorbance between 650 nm and 550 nm of a magenta toner, and the difference in absorbance between 500 nm and 600 nm of a cyan toner. Transparency of the individual OHP image was evaluated based on the following criteria, in which a value of at least 90B was judged to be rank A, a value of between 70-90B was judged to be rank B, and not more than 70B rank C. A sample having the value at least 70B is judged to be good transparency.

### (2) Charging Property

Evaluation of charging property was conducted by varying the electrostatic charge of every print. Thus, based on the following criteria, the value of nb/na was evaluated, where na is the electrostatic charge after setting a developer and making the first print and nb is the electrostatic charge after completion of printing of 1,000,000 sheets.
A: not less than 0.9 and less than 1.1,
B: not less than 0.8 and less than 0.9, or not less than 1.1 and less than 1.2,
C: not less than 0.7 and less than 0.8, or not less than 1.2 and less than 1.3,
D: less than 0.7 or more than 1.3,

### (3) Heat Resistance

A fixing roller and recovered silicone oil were visually observed and coloring was visually evaluated after obtaining 1,000,000 sheets of solid image formed on plain paper based on the following criteria:
A: no coloring was observed on the fixing roller and silicone oil,
B: coloring was observed in fixing roller and silicone oil.

### (4) Color Reproduction

Color reproduction of monochrome images on copy paper was visually evaluated by ten persons based on the following criteria. The most frequent rank was taken as the evaluation value, and the lowest rank was taken when the most frequent rank covers two or more ranks. Evaluation was conducted in a toner deposit amount of 0.7 H 0.05 mg/cm².

A: excellent color reproduction,

B: superior color reproduction,

C: slight color staining but acceptable in practice,

D: marked color staining and unacceptable in practice.

TABLE 2

| | | Evaluation | | | |
|---|---|---|---|---|---|
| | Toner | Color | Trans- | Charging | Heat |
| | No. | Reproduction | parency | Property | Resistance |
| Inv. 1 | 1 | A | A | B | A |
| Inv. 2 | 2 | A | A | A | A |
| Inv. 3 | 3 | B | A | A | B |
| Inv. 4 | 4 | A | A | A | B |
| Inv. 5 | 5 | B | B | A | B |
| Comp. 1 | 6 | A | A | D | D |
| Comp. 2 | 7 | B | D | B | B |
| Comp. 3 | 8 | C | D | D | A |

As apparent from Table 2, it was proved that Toner Nos. 1-5 according to the invention exhibited superior color reproduction, transparency charging property, and heat resistance, and forming images with enhanced image quality.

As for comparative toner 1, having D1/D2 value of 3 or more, though sufficient transparency was obtained and high color reproduction was attained, sufficient heat resistance and charging property were not obtained. As for comparative toner 2, having D1/D2 value of not more than 1, though it was proved to have high heat resistance, sufficient transparency was not obtained. As for comparative toner 3, employing a pigment but not a dye, though it was proved to have high heat resistance, sufficient transparency and color reproduction were not obtained.

What is claimed is:

1. A toner comprising a toner particle comprising a toner binder resin and minute colored particles containing a dye;
wherein the toner particle is obtained by dispersing the minute colored particles having a volume average particle diameter of D1 in the toner binder resin,
the toner particle satisfies formula of 3≧D2/D1>1,
wherein D2 is an average diameter of dye cloud formed by the colored particles in the toner particle.

2. The toner of claim 1, wherein the toner particle satisfies formula of 2.95≧D2/D1>1.05.

3. The toner of claim 1, wherein a difference between an SP value of the toner binder resin and an SP value RI WhH dyH RI WhH PinuWH FRORrHd SDrWiFOHs is 0-4 (cal/cm³)^{1/2}.

4. The toner of claim 1, wherein the dye is an oil-soluble dye.

5. The toner of claim 1, wherein the dye is a metal chelate dye.

6. The toner of claim 1, wherein the minute colored particles have a volume-average particle size of 10 nm to 1 μm.

7. The toner of claim 3, wherein the difference between an SP value of the toner binder resin and an SP value RI WhH dyH RI WhH PinuWH FRORrHd SDrWiFOHs is 0-3 (cal/cm³)^{1/2}.

8. The toner of claim 7, difference between an SP value of the toner binder resin and an SP value of the dye of WhH PinuWH FRORrHd SDrWiFOHs is 0.1-2.0 (FDO/FP³)^{1/2}.

9. The toner of claim 1, wherein the minute colored particles further contains a dye medium resin.

10. The toner of claim 9, wherein the minute colored particles are mixture of the dye and the dye medium resin.

11. The toner of claim 9, wherein the minute colored particles are core-shell particles in which the core comprises the dye and the shell comprises the dye medium resin.

12. The toner of claim 11, wherein the toner particle satisfies formula of 1.2≧D2/D1>1.05.

13. The toner of claim 11, wherein the shell contains no dye.

14. The toner of claim 11, wherein a thickness of the shHOO is 1-50 nP.

15. The toner of claim 11, wherein difference between an SP value of the dye medium resin of the shell and an SP vDOuH RI WhH dyH RI WhH PinuWH FRORrHd SDrWiFOHs is 0-3 (cal/cm³)^{1/2}.

16. The toner of claim 11, wherein the dye medium resin of the shell is different from the toner binder resin.

17. The toner of claim 9, wherein the dye medium resin is an acrylate resin, a methacrylate resin or a polystyrene resin.

18. The toner of claim 1, wherein a number-average molecular weight of the dye medium resin is from 500 to 100,000.

19. The toner of claim 18, wherein the number-average molecular weight of the dye medium resin is from 1,000 to 30,000.

20. The toner of claim 9, wherein the toner binding resin is different from the dye medium resin.

21. The toner of claim 20, wherein the dye medium resin has a number-average molecular weight of 3,000 to 6,000.

22. The toner of claim 1, wherein the dye content of the minute colored particles is 10B to 70B by weight.

23. A set of toners comprising yellow, magenta and cyan toners wherein each of the yellow, magenta and cyan toner composed of core-shell minute colored particles comprising shell resin and the shell of the yellow, magenta and cyan toner is composed the same resin.
